(19) United States
(12) Patent Application Publication
(10) Pub. No.: US 2011/0016265 A1
(43) Pub. Date: Jan. 20, 2011

(54) STORAGE DEVICE AND DATA PROCESS METHOD

(75) Inventor: Shih-Fang Hung, Chung Ho (TW)

Correspondence Address: Flash Intellectual Property, Inc.;Attn. Cheng-Ju Chiang, P.O. Box 766, Chino, CA, 91708, US

(73) Assignee: A-DATA TECHNOLOGY (SUZHOU) CO., LTD., SuZhou (CN)

(21) Appl. No.: 12/784,459

(22) Filed: May 20, 2010

(30) Foreign Application Priority Data
Jul. 15, 2009 (TW) 098123987

(51) Int. Cl. G06F 12/00; G06F 12/02

(52) U.S. Cl. 711/103; 711/E12.001; 711/E12.008

(57) ABSTRACT

A storage device includes a flash memory, a temporary storage unit, and a control unit. The flash memory includes a number of memory blocks, each of which has a number of pages. The temporary storage unit receives and stores a number of written commands transferred from a host system. Each written command is corresponding to user information. The control unit is coupled with the temporary storage unit and the flash memory, and adjusts executing sequence of the written commands according to a volume of the user information and unused pages in the memory block.

### BACKGROUND OF THE INVENTION

1. Field of the Invention

The present invention is related to a storage device and a data process method, and more particularly to a flash memory storage device and corresponding data process method.

2. Description of the Related Art

Most of conventional solid data storage device, such as Solid-State Disk (SSD), USB Flash Drive (UFD), storage card, etc. use NAND flash memory as a main storage media.

A functional diagram of SSD is shown as an example in FIG. 1. SSD 120 connects to Host System through a disk drive interface 130. Controller 140 executes the commands from the Host System through a system interface 110, and writes the data in or reads the data from the flash memory 150 according to logical address defined by the commands. In order to achieve the above-described function, the controller 140 should have a logical-to-physical (LTP) address translation function. A logical-to-physical address mapping table should be stored in the controller 140, in which the exact correspondence between the logical address and the physical address is recorded in the LTP address mapping table.

The Host System 100 transfers the Logical Page Address (LPA) of the stored data to the controller 140. The controller 140 converts the LPA to the Physical Page Address (PPA) of the flash memory according to the LTP address mapping table to thereby store the data in the flash memory 150.

The exact correspondence between the logical address and the physical address is shown in FIG. 2. If the Host System 100 successively transfers user information “0-2” to the controller 140, the logical addresses thereof will be the logical page “0” of the logical block “0”, the logical page “0” of the logical block “0” and “1”, and the logical page “1-4” of the logical block “0”. The controller 140 receives the writing command from the Host System 100 and provides an erased physical block “0” to write the user information according to the LTP address mapping table. The user information “0” is written to the physical page “0” of the physical block “0” and the correspondence between the physical page “0” of the physical block “0” and the logical page “0” of the logical block “0” is recorded in the LTP address mapping table. The user information “1” is written to the physical page “1, 2” of the physical block “0”, and then the LTP address mapping table is updated, in which the logical page “0” of the logical block “0” is corresponding to the physical page “0” of the physical block “1” and the logical page “1” of the logical block “1” is corresponding to the physical page “0” of the physical block “2”. The user information “2” is written to the physical page “3” of the physical block “0”. While, after writing the user information “2” of the logical page “2” of the logical block “0”, the physical block “0” has no storage room for writing the user information “2” of respective logical pages “3, 4”. Consequently, the controller 140 select the erased physical block “1” from the LTP address mapping table to continually write therein the user information “2”. The user information “2” of the logical pages “3, 4” of the logical block “0” is written in the physical page “0, 1” of the physical block “1” and the LTP address mapping table is updated, in which the logical pages “1, 2” of the logical block “0” are corresponding to the physical pages “3, 4” of the physical block “0”, and the logical pages “3, 4” of the logical block “1” is corresponding to the physical pages “0, 1” of the physical block “1”.

As described above, the user information “2” is divided and stored in respective physical blocks “0” and “1”. If the information is updated or deleted by the system, invalid pages will be generated in the two physical blocks. With the invalid pages in the physical block increasing, the controller 140 will obtain more storage space when reclaiming the invalid pages. However, once the user information is updated or deleted, since the invalid pages are located in two different physical blocks, it is not helpful for reclaiming the invalid pages. Moreover, the physical blocks which are required to be erased increase.

Hence, it is desired to provide a storage device with improved data process method to solve the above-described problems.

### SUMMARY OF THE INVENTION

Accordingly, an objective of the present invention is to provide a storage device and a data process method to improve storage speed.

A storage device in accordance with the present invention comprises a flash memory, a temporary storage unit, and a control unit. The flash memory comprises a plurality of memory blocks, each of which has a plurality of pages. The temporary storage unit receives and stores a plurality of written commands transferred from the host system. Each written command is corresponding to user information. The control unit is coupled with the temporary storage unit and the flash memory, and adjusts executing sequence of the written commands according to a volume of the user information and unused pages in the memory block.

A data process method in accordance with the present invention is used with a storage device, which connects with a host system and includes a plurality of blocks, each block having a plurality of pages. The method comprises the following steps: receiving and storing a plurality of commands from the host system, each command corresponding to user information; and adjusting executing sequence of the commands according to the volume of the user information and unused pages in the block.

Other objects, advantages and novel features of the invention will become more apparent from the following detailed description when taken in conjunction with the accompanying drawings.

### BRIEF DESCRIPTION OF THE DRAWINGS

FIG. 1 is a functional diagram of Solid-State Disk;

FIG. 2 is a correspondence chart between the logical address and the physical address;

FIG. 3 is a structural diagram of a storage device in accordance with the present invention;

FIG. 4A is a correspondence chart of the user information and the commands;

FIG. 4B is a schematics chart for storing user information;

FIG. 4C is a schematics chart of reclaiming invalid pages; and

FIG. 5 is a schematics chart of storing large volume information and small large volume information.

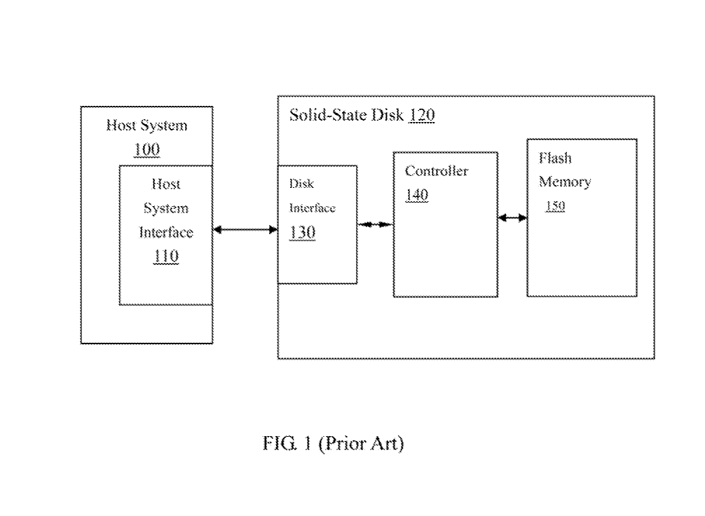

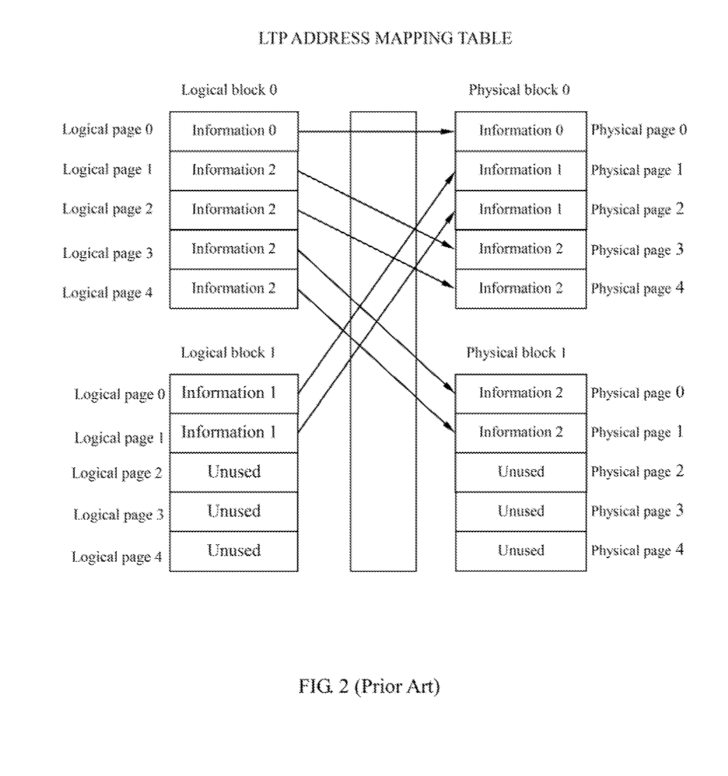

### DETAILED DESCRIPTION OF THE PREFERRED EMBODIMENTS

Reference will now be made in the detail to the preferred embodiments of the invention. While the present invention has been described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

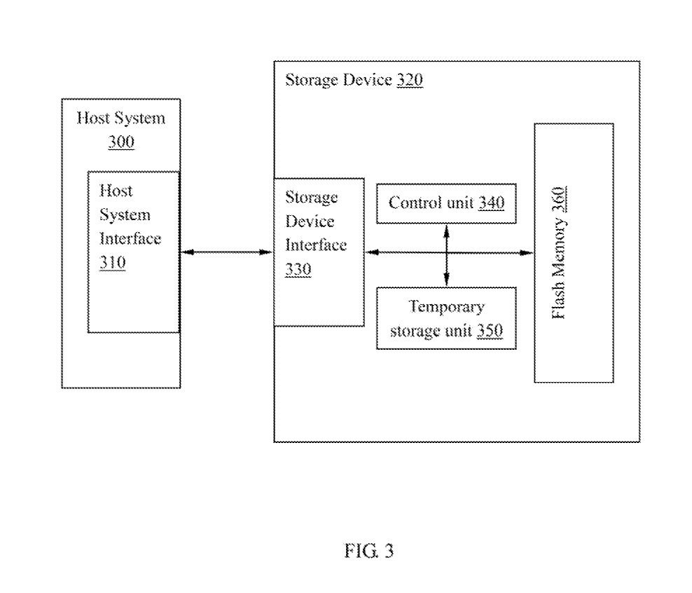

FIG. 3 shows a structural diagram of a storage device in accordance with the present invention. The storage device 320 includes storage device interface 330, a control unit 340, a temporary storage unit 350 and a flash memory 360. The storage device 320 connects with a host system interface 310 through a storage device interface 330 and exchanges the information with a host system 300. The temporary storage unit 350 receives and stores commands from the host system 300 as instruction sequence. The flash memory 360 has a plurality of memory blocks, i.e. physical blocks. Each memory block has at least one page, i.e. physical page. The control unit 340 adjusts the executing sequence of the commands in the instruction sequence according to allocation of the memory blocks in the flash memory 360. As can be understood, the temporary storage unit 350 and the control unit 340 can be included in a same controller. Also, the temporary storage unit 350 can be separated from the controller. That is, the control unit 340 is the controller, while the temporary storage unit 350 is extra set.

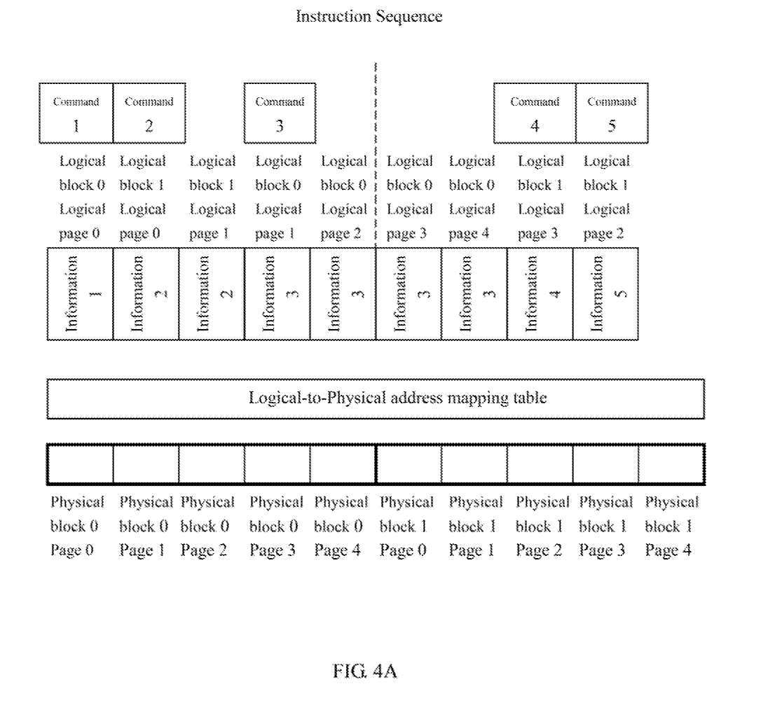

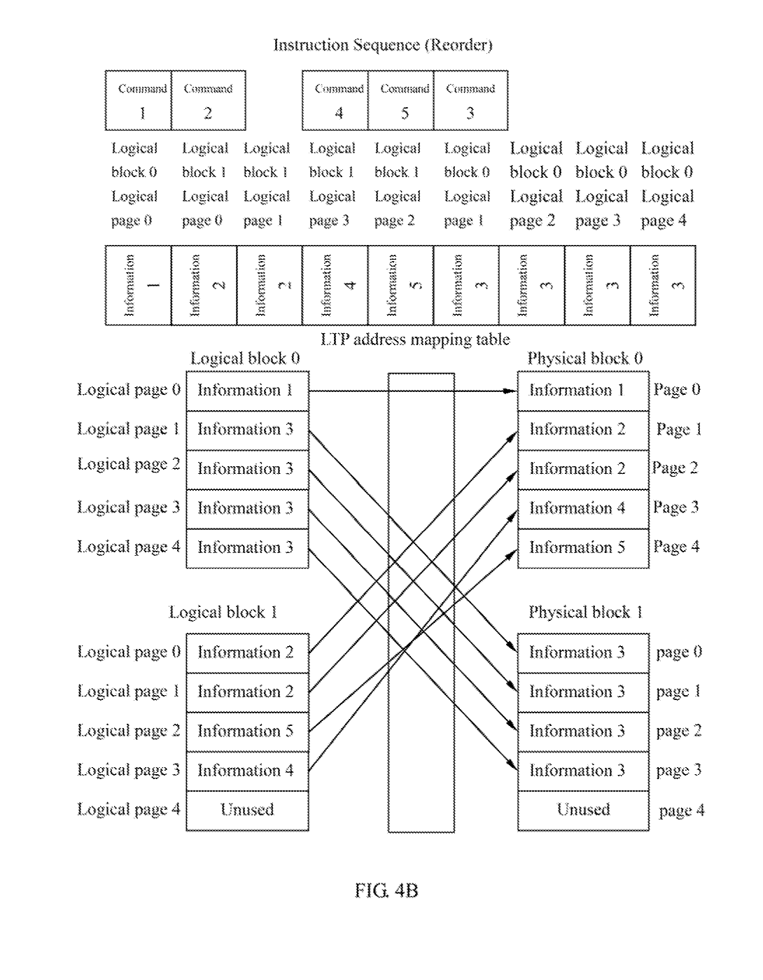

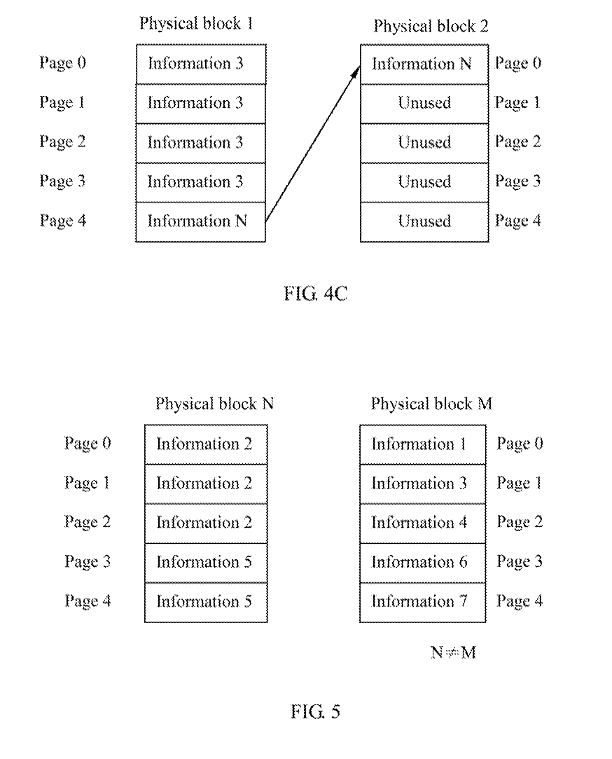

FIG. 4A is a correspondence chart of the user information and the written commands. It is assumed that each memory block of the flash memory 360 has five pages. The host system 300 successively transfers five commands 1-5 and corresponding user information 1-5 to the storage device 320. If the control unit 340 writes the information according to the sequence of the commands, the user information 3 will be divided and stored in the memory block 0 and the memory block 1. There are two pages remained in the memory block 0 which has no space for the command 3 of the user information 3, after the user information 1 and 2 are written in sequence. Therefore, the control unit 340 needs to find the command of other user information in the instruction sequence according to the Logical-to-Physical (LTP) address mapping table. The volume of this user information should be smaller than the remained storage space in the memory block 0. In other words, the control unit 340 needs to check the commands in the instruction sequence that whether the corresponding user information can be integratedly written into the remained space of the memory block 0. If such user information is found, the corresponding command will be written in high priority.

FIG. 4B is a schematics chart for storing user information. As described above, the remained pages 3 and 4 in the memory block 0 can store the user information 4 and 5. The control unit 340 writes the commands 4 and 5 before writing the command 3. The user information 4, 5 are allocated to pages 3, 4 in the memory block 0 and then the LTP address mapping table is correspondingly updated. After writing the commands 4 and 5, the memory block 0 is full of user information. When it is the command 3 to be written, an erased memory block in the flash memory 360 will be selected to write the command 3. The control unit 340 writes the user information 3 in the pages 1-3 of the memory block 1 and correspondingly updates the LTP address mapping table. In this way, the user information 3 can be stored in a same memory block.

After writing the command 3, there is only one page is remained in the memory block. If the next written information is larger than the volume of a page, the control unit 340 will stay writing operation of this command. While, the command, the volume of which is smaller or equal to one page, will be written in priority.

FIG. 4C is a schematics chart of reclaiming invalid pages. Assumed that the user information N is written in the page 4 of the memory block 1 and the user information 3 is deleted or updated, the pages 0-3 of the memory block 1 will be invalid pages. During reclaiming invalid pages, the control unit 340 needs to select a memory block with more invalid pages in the flash memory 360. If the memory block 1 is selected, the control unit 340 will firstly copy the user information N in page 4 of the memory block 1 to the erased page 0 of the memory block 2 and correspondingly updates LTP address mapping table. Then, the memory block 1 is erased and pages 1-4 of the memory block 2 are released. As can be seen that, when user information is invalidated, which is recorded in a same block, the invalid user information will be concentrated generated in the same block. It is helpful for the control unit 340 to search the block with more invalidated information and the efficiency of reclaiming invalid pages is improved.

In the present invention, since a small volume user information can be dealt with in advance, the time the storage device 320 responding to the host system 300 is shorten. Hence, the efficiency of the storage device 320 is improved.

The present invention can provide another method to order the executing sequence of the commands. The memory blocks of the flash memory 360 include large volume block for storing large volume of information and small volume block for storing small volume of information. If the storage space of the large volume block is not enough to store user information with a large volume, appropriate written information can be filled into the remained space of this block according to above-described method. The volume of the information can be defined by a preset value. Consequently, most of large volume information and small volume information are stored in different memory blocks.

FIG. 5 is a schematics chart of storing large volume information and small large volume information. First, the host system 300 successively transfers user information 1-7 to the control unit 340. The volumes of the user information 1, 3, 4, 6 and 7 are respectively equal to one page and the volume of the user information 2 is equal to three pages. The volume of the user information 5 is equal to two pages. If the control unit 340 presets one page as a preset value for user information, a large volume information is the information larger than one page and a small volume information is the information smaller than one page. Therefore, the control unit 340 stores the small volume information 1, 3, 4, 6 and 7 into memory block M and the large volume information 2, 5 into memory block N.

Additionally, there are two methods to order the sequence of executing commands. The first method decides the sequence according to types of blocks of the control unit 340. When the control unit 340 is storing a small volume block, the instruction sequence will be reordered and the command of small volume information will be written in priority. On the other hand, when the control unit 340 is storing a large volume block, the instruction sequence will be reordered and the command of large volume information will be written in priority.

Referring to FIG. 5, the control unit 340 first receives the user information 1 and writes the user information into the memory block M. The rest information will be reordered in the instruction sequence and the command of small volume information will be executed in advance. In the embodiment, the control unit 340 writes the user information 3, 4, 6 and 7 into the memory block M. After the user information 7 is written, the control unit 340 writes the large volume information 2 and 5 into the memory block N.

On the contrary, when the control unit 340 is storing a large volume block, the command of large volume information can be executed in priority until the remained space of the block is small than a volume of next information to be stored. At this time, appropriate information will be selected from the instruction sequence and written to the remained space of the block.

The second method is to execute the command with a small volume of information to thereby speed up the time of the control unit 340 responded to the host system 300. As described above, when the host system 300 transfers the information 1-7, the control unit 340 will preferably execute the commands of small volume of information and write successively the user information 1-7 into one memory block of the flash memory 360. Then, the user information 2, 5 are written into another memory block.

As a whole, the present invention adjusts the execute order according to the volumes of the user information to be written therein to thereby efficiently allocate the pages and speed up the responding time.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. A storage device connecting with a host system, comprising:
a flash memory, comprising a plurality of memory blocks, each memory block comprising a plurality of pages;
a temporary storage unit, receiving and storing a plurality of written commands from the host system, each written command corresponding to a user information; and
a control unit, coupled with said temporary storage unit and said flash memory, adjusting executing sequence of the written commands according to a volume of the user information and unused pages in said memory block.

2. The storage device as claimed in claim 1, wherein a preset value is set by the control unit, and the memory blocks are sorted to a large volume block for storing a large volume of information larger than the preset value and a small volume block for storing a small volume of information smaller than the preset value.

3. The storage device as claimed in claim 2, wherein if the control unit is executing the command of said small volume block, the executing sequence will be adjusted to execute the command with small volume of information in priority; and if the control unit is executing the command of said large volume block, the executing sequence will be adjusted to execute the command with large volume of information in priority.

4. The storage device as claimed in claim 2, wherein the control unit executes the command with small volume of information in priority.

5. The storage device as claimed in claim 1, wherein according to the volume of unused pages in said memory block, the control unit selects the user information, the volume of which is smaller or equal to the volume of the unused pages and execute the commands of such user information in priority.

6. A data process method, used with a storage device, which connects with a host system and includes a plurality of blocks, each block having a plurality of pages, said method comprising the following steps:
receiving and storing a plurality of commands from the host system, each command corresponding to a user information; and
adjusting executing sequence of said commands according to the volume of the user information and unused pages in said block.

7. The data process method as claimed in claim 6, further comprising the following steps:
comparing user information and a preset value, wherein the volume of the information larger than the preset value will be regarded as a large information and the volume of the information smaller than the preset value will be regarded as a small information; and
dividing the blocks into small volume block for storing a small information and large volume block for storing a large information.

8. The data process method as claimed in claim 7, wherein the step of adjusting executing sequence of said commands further comprises the following steps:
adjusting the executing sequence of the commands according to types of the storing blocks;
adjusting the executing sequence to write a small user information in priority if a small volume block is employed to store the user information; and
adjusting the executing sequence to write a large user information in priority if a large volume block is employed to store the user information.

9. The data process method as claimed in claim 7, wherein the step of adjusting executing sequence of said commands further comprises the following step:
adjusting the executing sequence to write a large volume of information in priority.

10. The data process method as claimed in claim 6, further comprising the following step:
selecting the user information the volume of which is smaller or equal to the volume of the unused pages and executing the commands of such user information in priority, according to the volume of unused pages in said memory block.
